(19) United States
(12) Patent Application Publication
(10) Pub. No.: US 2022/0135491 A1
(43) Pub. Date: May 5, 2022

(54) ULTRA-HIGH DENSITY CONCRETE COMPOSITION, MANUFACTURING METHOD OF SUCH CONCRETE COMPOSITION, CONCRETE MEMBER MADE BY SUCH CONCRETE COMPOSITION, AND MANUFACTURING METHOD OF SUCH CONCRETE MEMBER

(71) Applicant: KOREA INSTITUTE OF CIVIL ENGINEERING AND BUILDING TECHNOLOGY, Goyang-si (KR)

(72) Inventors: Kyung-Taek KOH, Paju-si (KR); Gum-Sung RYU, Goyang-si (KR); Byung-Suk KIM, Goyang-si (KR); Gi Hong AN, Paju-si (KR); Jong-Dae BAEK, Goyang-si (KR); Jae-Yoon KANG, Goyang-si (KR); Jae-Joon SONG, Seoul (KR)

(21) Appl. No.: 17/512,583

(22) Filed: Oct. 27, 2021

(30) Foreign Application Priority Data
Nov. 3, 2020 (KR) 10-2020-0145417

(51) Int. Cl. C04B 41/45; C04B 41/50

(52) U.S. Cl. CPC C04B 41/4596; C04B 41/50; C04B 2201/52; C04B 2201/20; C04B 41/4505

(57) ABSTRACT

The present disclosure relates to ultra-high density concrete composite containing super-absorbent polymer (SAP)-Attached Fibers, suitable for making a near-vacuum tube for hyperloop transportation system, a method for manufacturing the ultra-high density concrete composite, a method for manufacturing a concrete member using the ultra-high density concrete composite and an ultra-high density concrete member manufactured by the method.

### CROSS-REFERENCE TO RELATED APPLICATION

This application claims priority to Korean Patent Application No. 10-2020-0145417, filed on Nov. 3, 2020, and all the benefits accruing therefrom under 35 U.S.C. § 119, the contents of which in its entirety are herein incorporated by reference.

### BACKGROUND

### 1. Field

The present disclosure relates to an ultra-high density concrete composition suitable for making a near-vacuum tube for a hyperloop transportation system, a method for manufacturing the ultra-high density concrete composition, a method for manufacturing a concrete member using the ultra-high density concrete composition and an ultra-high density concrete member manufactured by the method.

### 2. Description of the Related Art

As the future transportation means, there is an increasing attention to a hyperloop transportation system that can carry vehicles at high speeds in a near-vacuum tube or tunnel. Suggestions are made to manufacture the near-vacuum tube for the hyperloop transportation system using a steel tube with an aim to easily maintain the near-vacuum condition. The near-vacuum tube made of steel has the outstanding airtightness maintenance performance, but as the diameter increases, it is difficult to manufacture and economical efficiency reduces. Additionally, the near-vacuum tube made of steel may have reduced serviceability due to the corrosion of steel.

The near-vacuum tube made of concrete (“Concrete Tube”) may be an alternative to the near-vacuum tube made of steel for the hyperloop transportation system. It may be difficult to maintain airtightness if the Concrete Tube is manufactured using ordinary concrete. Additionally, when the Concrete Tube is manufactured using ordinary concrete, it is necessary to increase the cross-sectional thickness to maintain airtightness, and in this case, it is difficult to construct, the risk of cracking caused by heat of hydration is high, and there is a very high likelihood that durability will decrease.

The use of Ultra High Performance Concrete (“UHPC”), not ordinary concrete, may be considered. The UHPC has a very dense matrix. Additionally, The UHPC has the outstanding airtightness maintenance performance, as well as high compressive strength and tensile strength. Accordingly, when the Concrete Tube are manufactured using the UHPC, it is expected to greatly reduce the cross-sectional thickness of the near-vacuum tube. Additionally, the UHPC has high durability, and accordingly the UHPC may be suitable as a material for manufacturing the near-vacuum tube.

However, since the UHPC has a very low water-binder composition ratio (“W/B ratio”) and use large amounts of binder compositions and fine materials, there is a risk of cracking caused by autogenous shrinkage. Accordingly, to manufacture a near-vacuum tube using the UHPC, it is necessary to find a way to effectively suppress or control the shrinkage and consequential cracks.

### SUMMARY

The present disclosure is developed to overcome the limitations of the related art and therefore the present disclosure is directed to providing an ultra-high density concrete composition for efficiently manufacturing a concrete member such as a near-vacuum tube for hyperloop transportation system, and a method for manufacturing the ultra-high density concrete composition.

The present disclosure is further directed to providing a method for manufacturing an ultra-high density concrete member using the ultra-high density concrete composition and an ultra-high density concrete member manufactured by the method.

To achieve the above-described object, the present disclosure provides an ultra-high density concrete composition including cement, reactive powder, filler, fine aggregate, admixture, mixing water and reinforcing fiber, wherein the reactive powder is included in an amount of 10 to 30 parts by weight, the filler is included in an amount of 15 to 30 parts by weight, the fine aggregate is included in an amount of 100 to 150 parts by weight, and the admixture is included in an amount of 0.1 to 1 parts by weight, based on 100 parts by weight of cement, and the reinforcing fiber is a super-absorbent polymer (“SAP”)-Attached Fibers in which SAP is mixed with the reinforcing fiber and uniformly attached to a surface of the reinforcing fibers by an adhesive.

To achieve the above-described object, the present disclosure further provides a method for manufacturing ultra-high density concrete composition including cement, reactive powder, filler, fine aggregate, admixture, mixing water and reinforcing fiber, the method including metering 10 to 30 parts by weight of reactive powder, 15 to 30 parts by weight of filler and 100 to 150 parts by weight of fine aggregate based on 100 parts by weight of cement, and uniformly mixing the cement, the reactive powder, the filler and the fine aggregate (step 1), and adding admixture, mixing water and reinforcing fiber to the mixture of the step 1 and mixing together (step 2), wherein 0.1 to 1 parts by weight of admixture is metered and fed based on 100 parts by weight of cement, and the reinforcing fiber is an SAP-Attached Fiber in which SAP is mixed with the reinforcing fiber and uniformly attached to a surface of the reinforcing fiber by an adhesive.

To achieve the above-described object, the present disclosure further provides a method for manufacturing a concrete member using the ultra-high density concrete composition of the present disclosure, the method including pouring the ultra-high density concrete composition into a mold, curing and demolding, covering an upper surface of the ultra-high density concrete composition poured into the mold with a curing blanket of vinyl to prevent the evaporation of moisture from the ultra-high density concrete composition during curing, and after 1 to 2 days while maintaining temperature of 15 to 40° C. and humidity of 90% or more, demolding by removing the mold, and after the demolding is completed, performing high temperature thermal curing for 1 to 3 days while maintaining the temperature of 50 to 98° C. and the humidity of 95% or more, or performing wet curing for 7 days or more while maintaining the temperature of 15° C. or more and the humidity of 95% or more, and an ultra-high density concrete member manufactured by the method.

In the ultra-high density concrete composition of the present disclosure, the method for manufacturing the same, the method for manufacturing a concrete member using the ultra-high density concrete composition and the ultra-high density concrete member manufactured by the method, the SAP-Attached Fiber may be manufactured by metering 0.1 to 1.5 weight % of SAP and 98.5 to 99.5 weight % of reinforcing fiber based on 100 weight % or the total weight of the SAP and the reinforcing fiber, and mixing the SAP and the reinforcing fiber with the adhesive and drying.

Further, in the ultra-high density concrete composition of the present disclosure, the method for manufacturing the same, the method for manufacturing a concrete member using the ultra-high density concrete composition and the ultra-high density concrete member manufactured by the method, the SAP-Attached Fiber may be an SAP-Attached Steel Fiber, in which the reinforcing fiber, to which the SAP is attached, is a steel fiber, the SAP-Attached Steel Fiber may be included in an amount of 10 to 40 parts by weight based on 100 parts by weight of cement, the mixing water may include basic mixing water and additional mixing water, the basic mixing water may be included in an amount of 15 to 25 parts by weight based on 100 parts by weight of cement, and the additional mixing water may be included in an amount of 0.39 to 1.39 parts by weight based on 100 parts by weight of cement, and in contrast, the SAP-Attached Fiber may be an SAP-Attached Organic Fiber, in which the reinforcing fiber, to which the SAP is attached, is an organic fiber, the SAP-Attached Organic Fiber may be included in an amount of 1 to 5 parts by weight based on 100 parts by weight of cement, the mixing water may include basic mixing water and additional mixing water, the basic mixing water may be included in an amount of 15 to 25 parts by weight based on 100 parts by weight of cement, and the additional mixing water may be included in an amount of 0.39 to 1.70 parts by weight based on 100 parts by weight of cement.

In particular, the ultra-high density concrete member according to the present disclosure may be a near-vacuum tube for hyperloop transportation system.

According to the present disclosure, it is possible to manufacture ultra high density concrete with improved flowability, mechanical properties, shrinkage characteristics and airtightness. Using the ultra-high density concrete composition of the present disclosure, it is possible to manufacture concrete members having dense structures with very high density.

Therefore, according to the present disclosure, it is possible to manufacture very efficiently and successfully concrete structures such as near-vacuum tubes for hyperloop transportation system that can carry vehicles at high speeds.

### BRIEF DESCRIPTION OF THE DRAWINGS

FIG. 1 is a graph showing the result of experimentally calculating an amount of additional mixing water relative to steel fiber.

FIG. 2 is a graph showing the result of experimentally calculating an amount of additional mixing water relative to polyvinyl alcohol (PVA) fiber.

### DETAILED DESCRIPTION

Hereinafter, the present disclosure is described with reference to the preferred embodiment of the present disclosure, but the technical spirit of the present disclosure and the key elements and operations are not limited to the embodiments.

The ultra-high density concrete composition according to the present disclosure includes cement, reactive powder, filler, fine aggregate, admixture, mixing water and reinforcing fibers, but as opposed to the existing UHPC, the ultra-high density concrete composition according to the present disclosure includes “Super-Absorbent Polymer (“SAP”)-Attached Fibers” as the reinforcing fibers.

The reactive powder includes at least one selected from the group consisting of silica fume, fine powder of blast furnace slag, fly ash, nano-silica, and metakaolin. The reactive powder is included in an amount of 10 to 30 parts by weight based on 100 parts by weight of cement.

The filler includes quartz fine powder and limestone fine powder used alone or in combination. The filler is included in an amount of 15 to 30 parts by weight based on 100 parts by weight of cement.

The fine aggregate includes silica or natural sand used alone or in combination. The fine aggregate is included in an amount of 100 to 150 parts by weight based on 100 parts by weight of cement.

The admixture may include a polycarbonate based high performance water reducer. The admixture is included in an amount of 0.1 to 1 parts by weight based on 100 parts by weight of cement.

The ultra-high density concrete composition according to the present disclosure includes the reinforcing fibers. The reinforcing fibers includes steel fiber or organic fiber. The reinforcing fiber used in the present disclosure is used in the form of “SAP-Attached Fibers” in which SAP is mixed with the reinforcing fibers and, therefore, SAP is uniformly attached to the surface of the reinforcing fibers. The SAP-Attached Fibers may act as a material for improving the strength and shrinkage characteristics of a concrete member. The organic fiber as the reinforcing fiber may include polyvinyl alcohol nylon fiber (PVA fiber), carbon fiber, nylon fiber, polyethylene fiber (PE fiber), and the steel fiber may have the diameter of 0.15 to 0.25 mm, an aspect ratio (a length-to-diameter ratio) of 65 to 100, and the tensile strength of 2,000 MPa or more. Of course, the type of steel fiber and organic fiber is not limited thereto.

SAP is an ingredient included to reduce the shrinkage and cracks of concrete. SAP absorbs water, but SAP releases water during drying. In the case of concrete using SAP, expanded SAP shrinks in the curing process of the concrete, and as a consequence, pores are formed in the concrete as much as the shrinkage of SAP. To prevent such phenomenon, the ultra-high density concrete composition of the present disclosure may use SAP composed of spherical particles having a small particle size. In this instance, the particle size of the spherical particles of SAP may be 5 to 30 μm. As the present disclosure uses SAP having a small particle size, the size of the pores formed due to the shrinkage of SAP reduces below 10 μm, thereby minimizing the influence on the strength of the ultra-high density concrete composition.

Additionally, in case that SAP is used, the irregular distribution and dispersion of SAP in the concrete composition may cause different volume changes for each cross-sectional region of a concrete member or structure. To prevent this phenomenon, in the manufacture of the ultra-high density concrete composition according to the present disclosure, it is provided with a method for uniformly attaching SAP to the surface of the reinforcing fibers. The ultra-high density concrete composition according to the present disclosure use SAP and reinforcing fibers to improve the tensile strength and shrinkage characteristics of a concrete member or structure. Further, the ultra-high density concrete composition according to the present disclosure uses “SAP-Attached Fibers” in which SAP is uniformly attached to the surface of the reinforcing fibers. Using the SAP-Attached Fibers, SAP is uniformly dispersed and distributed in the ultra-high density concrete composition, and accordingly, volume changes are uniformly exhibited over the entire concrete member or structure made of the ultra-high density concrete composition, thereby uniformly controlling the shrinkage and cracks.

To prepare “SAP-Attached Fiber” by uniformly attaching SAP to the surface of reinforcing fibers, the following operation is performed.

(1) Prepare spherical SAP of a small particle size (preferably, the particle size of 5-30 μm) manufactured by suspension polymerization metered at 0.5 to 1.5% by weight. In addition, prepare reinforcing fibers metered at 98.5 to 99.5% weight. That is, 0.1 to 1.5 weight % of SAP and 98.5 to 99.5 weight % of reinforcing fibers are prepared based on 100 weight % of the total weight of SAP and the reinforcing fibers.

(2) Prepare an adhesive. The adhesive is a mixture of a vegetable adhesive base, for example, starch, and a viscosity stabilizer. The adhesive is prepared by mixing 99.0 to 99.8 weight % of vegetable adhesive base and 0.2 to 1.0 weight % of viscosity stabilizer based on 100 weight % of the total weight of the adhesive. In this instance, the vegetable adhesive base and the viscosity stabilizer may be put into a stirrer and mixed at the speed of 50 to 80 rpm for 60 to 100 sec. to prepare a liquid adhesive.

(3) SAP, the reinforcing fiber and the adhesive are mixed and dried to manufacture “SAP-Attached Fibers”. In detail, “SAP-Attached Fibers” may be manufactured by i) putting SAP and the reinforcing fibers into a stirrer at the above-described weight ratio, i.e., 0.1 to 1.5 weight % of SAP and 98.5 to 99.5 weight % of reinforcing fibers based on 100 weight % of the total weight of SAP and the reinforcing fibers, ii) putting the adhesive including the vegetable adhesive base and the viscosity stabilizer into the stirrer in an amount of 3 to 7 parts by weight based on 100 parts by weight of SAP and the reinforcing fiber before, after or in parallel with putting SAP and the reinforcing fiber, and iii) mixing and iv) air drying. In this instance, SAP, the reinforcing fiber and the adhesive may be stirred and mixed in the stirrer at the speed of 20 to 50 rpm for 100 to 180 sec., and air dried at 20 to 30° C. for 1 hour or longer.

The “SAP-Attached Fibers” may be manufactured by the above-described process. The ultra-high density concrete composition according to the present disclosure includes the SAP-Attached Fibers, and in this instance, the amount of SAP-Attached Fibers to be used in the ultra-high density concrete composition may depend on the type of the reinforcing fibers. In the case of the SAP-Attached Fibers manufactured using steel fibers as the reinforcing fibers, i.e., “SAP-Attached Steel Fibers”, the ultra-high density concrete composition of the present disclosure includes the SAP-Attached Steel Fibers in an amount of 10 to 40 parts by weight based on 100 parts by weight of cement.

In the case of the SAP-Attached Fibers using organic fibers as the reinforcing fibers, i.e., “SAP-Attached Organic Fibers”, the ultra-high density concrete composition of the present disclosure includes the SAP-Attached Organic Fibers in an amount of 1 to 5 parts by weight based on 100 parts by weight of cement.

When the SAP-Attached Steel Fibers are included in an amount of less than 10 parts by weight, the strength and shrinkage characteristics improvement of the SAP-Attached Steel Fibers is not effective. When the SAP-Attached Steel Fibers are included in an amount of more than 40 parts by weight, rather some adverse effects occur, and the production costs greatly increase. Likewise, when the SAP-Attached Organic Fibers are included in an amount of less than 1 part by weight, the strength and shrinkage characteristics improvement is not so effective. When the SAP-Attached Organic Fibers are included in an amount of more than 5 parts by weight, there are problems with the negative influence on the strength and shrinkage characteristics and a rise in production costs.

Since SAP will absorb water, it is necessary to increase the amount of mixing water when SAP is included in the concrete composite. When the mixing water is used in an amount calculated without considering SAP, the workability of concrete composite will be reduced since SAP absorbs the mixing water, and as a consequence, the ingredients (each ingredient of concrete composition) are poorly mixed or water necessary for hydration reaction is insufficient. Accordingly, it is necessary to calculate the amount of mixing water taking into account the amount of water absorbed by SAP and its consequential reduction in slump flow.

As previously described, SAP attached to the surface of the reinforcing fibers is used in the present disclosure. Additionally, the slump flow of concrete composition is significantly affected by the amount of reinforcing fibers. As described above, in the ultra-high density concrete composition of the present disclosure, the amount of “SAP-Attached Fiber” is depending on the type of reinforcing fibers. Therefore, the amount of mixing water is also depending on the type of reinforcing fibers. In the ultra-high density concrete composition of the present disclosure, the mixing water is classified into (A) “basic mixing water” and (B) “additional mixing water”. Accordingly, an amount of mixing water is the sum of “an amount of basic mixing water” and “an amount of additional mixing water”. The “amount of basic mixing water” is an amount that is set irrespective of the use of SAP and the type of reinforcing fiber. However, the “amount of additional mixing water” is set according to the type of SAP-Attached Fibers.

In the ultra-high density concrete composite of the present disclosure, the basic mixing water is included in an amount of 15 to 25 parts by weight based on 100 parts by weight of cement. That is, the amount of basic mixing water is 15 to 25 parts by weight based on 100 parts by weight of cement. The additional mixing water is included in different amounts depending on the type of reinforcing fibers. If the reinforcing fibers are steel fiber, the amount of additional mixing water is 0.39 to 1.39 parts by weight based on 100 parts by weight of cement. However, if the reinforcing fibers are organic fiber, the amount of additional mixing water is 0.39 to 1.70 parts by weight based on 100 parts by weight of cement.

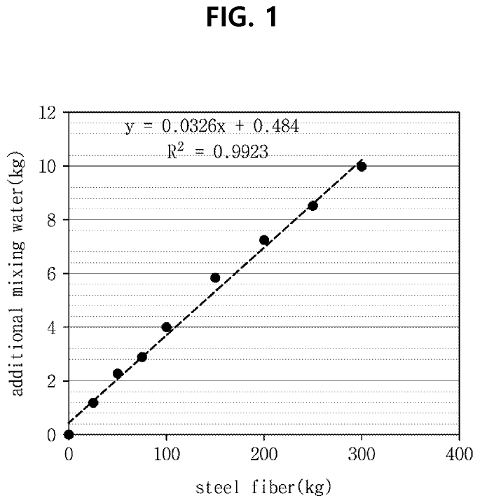

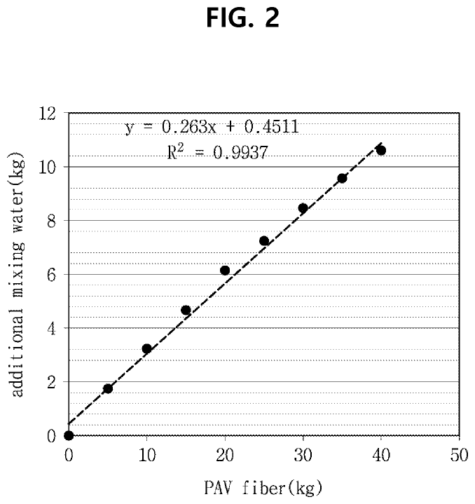

In the present disclosure, the amount of additional mixing water dependent on the type of reinforcing fiber is experimentally determined on the basis of the target slump flow satisfying 600 to 800 mm. FIGS. 1 and 2 show graphs showing the results of experimentally calculating the amount of additional mixing water for each of steel fiber and PVA fiber. FIG. 1 shows the following Equation 1 and FIG. 2 shows the following Equation 2. Equations 1 and 2 are regression equations showing lines indicated as dashed lines in FIGS. 1 and 2, respectively. In Equations 1 and 2, “x” denotes the amount of fiber and “y” denotes the amount of additional mixing water.

y=0.0326x+0.484 [Equation 1]

y=0.263x+0.4511 [Equation 2]

In more detail, if the reinforcing fibers are steel fiber, the amount of additional mixing water may be included in a value (“y” value) calculated by the above Equation 1 using the actual amount (“x” value) of steel fiber within the range of 0.39 to 1.39 parts by weight based on 100 parts by weight of cement. If the reinforcing fibers are organic fiber, and the amount of additional mixing water may be included in a value calculated by the above Equation 2 within the range of 0.39 to 1.70 parts by weight based on 100 parts by weight of cement.

A method for manufacturing the ultra-high density concrete composition according to the present disclosure having the above-described configuration includes the following process as described in detail below.

(Step 1) Cement, reactive powder, filler and fine aggregate are metered in the above-described amounts and mixed together to uniformly mix and distribute the ingredients. The mixing may be performed by the dry mix process at the mixing speed of about 15 to 50 rpm for 30 to 180 sec.

(Step 2) Admixture, mixing water and SAP-Attached Fibers are metered in the above-described amounts and added to the mixture prepared in the above step 1 and they are mixed together. In this instance, the mixture prepared in Step 1, admixture and basic mixing water may be put together into the mixing device, and would be mixed at the mixing speed of about 30 to 70 rpm for about 1 min 30 sec to 5 min. Subsequently additional mixing water and SAP-Attached Fibers may be put into the mixing device, and mixed at the mixing speed of about 50 to 100 rpm for about 1 min to 3 min (“Primary Mixing”), and additionally mixed at the mixing speed of about 5 to 15 rpm for about 2 min to 5 min (“Secondary Mixing”). By this process, bubbles created during the mixing may be effectively removed.

In particular, according to the present disclosure, the mixing water may be fed in two divided times. The <basic mixing water> is fed to allow SAP to absorb water, and subsequently, the <additional mixing water> is fed. When the mixing water is fed two divided times, workability is improved, and accordingly it is possible to reduce the amount of high performance water reducer used. Of course, simultaneously feeding the basic mixing water and the additional mixing water is not completely precluded.

As described above, the ultra-high density concrete composition of the present disclosure uses the “SAP-Attached Fibers”. The process of preparing the “SAP-Attached Fibers” is described in detail above, and in this instance, the preparation of the “SAP-Attached Fibers” may be completed before the Secondary Mixing. That is, the preparation of the SAP-Attached Fibers may be performed before the Secondary Mixing described in the above, or may be performed before, after or in parallel with the Primary Mixing described in the above.

When the ultra-high density concrete composition according to the present disclosure is made by the above-described process, a concrete member is manufactured by pouring the ultra-high density concrete composition into a prepared mold, curing and demolding. In the manufacture of the concrete member according to the present disclosure, the curing and demolding may be performed by the following process.

First, in the curing, the upper surface of the ultra-high density concrete poured into the mold is covered with a curing blanket of vinyl to prevent the evaporation of moisture from the ultra-high density concrete, and after 1 to 2 days while maintaining the temperature of 15 to 40° C. and the humidity of 90% or more, demolding is performed by removing the mold. After demolding, high temperature thermal curing is performed for 1 to 3 days while maintaining the temperature of 50 to 98° C. and the humidity of 95% or more, or wet curing is performed for 7 days or more while maintaining the temperature of 15° C. or more and the humidity of 95% or more. Through the above-described process, it is possible to manufacture a concrete member having high airtightness very effectively using the ultra-high density concrete composition of the present disclosure.

Subsequently, examples of the present disclosure and comparative examples for comparison will be described.

First, to verify the influence and effect of additional mixing water and “SAP-Attached Fibers”, comparative examples and examples of the present disclosure are prepared with the following composition.

### Comparative Example 1-1

Concrete composition including cement, silica fume as reactive powder, quartz fine powder as filler, silica sand as fine aggregate, a polycarbonate-based high performance water reducer as admixture, basic mixing water, and steel fibers as reinforcing fiber without SAP and additional mixing water.

The details of the concrete composition of Comparative example 1-1 are as follows:
Cement of 100 parts by weight;
Silica fume of 20 parts by weight;
Quartz fine powder of 25 parts by weight;
Silica sand of 110 parts by weight;
Polycarbonate-based high performance water reducer of 0.45 parts by weight;
Basic mixing water of 20 parts by weight; and
Steel fibers of 22 parts by weight.

### Comparative Example 1-2

Concrete composition including cement, silica fume as reactive powder, quartz fine powder as filler, silica sand as fine aggregate, a polycarbonate-based high performance water reducer as admixture, basic mixing water, steel fibers as reinforcing fiber, and SAP without additional mixing water.

In the Comparative example 1-2, SAP is not attached to the steel fiber, and therefore, SAP is separate from steel fibers.

The details of the concrete composition of Comparative example 1-2 are as follows:
Cement of 100 parts by weight;
Silica fume of 20 parts by weight;
Quartz fine powder of 25 parts by weight;
Silica sand of 110 parts by weight;
Polycarbonate-based high performance water reducer of 0.45 parts by weight;
Basic mixing water of 20 parts by weight;
Steel fibers of 22 parts by weight; and
SAP of 1 part by weight.

### Comparative Example 1-3

Concrete composition including cement, silica fume as reactive powder, quartz fine powder as filler, silica sand as fine aggregate, a polycarbonate-based high performance water reducer as admixture, basic mixing water, and SAP-Attached Steel Fibers as reinforcing fiber without additional mixing water.

The details of the concrete composition of Comparative example 1-3 are as follows:
Cement of 100 parts by weight;
Silica fume of 20 parts by weight;
Quartz fine powder of 25 parts by weight;
Silica sand of 110 parts by weight;
Polycarbonate-based high performance water reducer of 0.45 parts by weight;
Basic mixing water of 20 parts by weight; and
SAP-Attached Steel Fibers of 23 parts by weight.

### Example 1-1 of the Present Invention

Ultra-high density concrete composition including cement, silica fume as reactive powder, quartz fine powder as filler, silica sand as fine aggregate, a polycarbonate-based high performance water reducer as admixture, basic mixing water, additional mixing water, and SAP-Attached Steel Fibers as reinforcing fiber.

The details of the concrete composition of Example 1-1 are as follows:
Cement of 100 parts by weight;
Silica fume of 20 parts by weight;
Quartz fine powder of 25 parts by weight;
Silica sand of 110 parts by weight;
Polycarbonate-based high performance water reducer of 0.45 parts by weight;
Basic mixing water of 20 parts by weight;
Additional mixing water of 0.81 parts by weight; and
SAP-Attached Steel Fibers of 23 parts by weight.

Common to all of Comparative example 1-1, Comparative example 1-2, Comparative example 1-3 and Example 1-1 of the present invention, cement, silica fume, quartz fine powder and silica sand are put together into a mixer and mixed by the dry mix process at the mixing speed of 30 rpm for 1 min 30 sec. such that those materials are uniformly distributed. Sequentially, basic mixing water and admixture are added to the dry mixed materials as described and mixed at the mixing speed of 50 rpm for 2 min 30 sec. Thereafter, steel fibers, SAP, SAP-Attached Steel Fibers and additional mixing water are additionally fed to the mixture according to the composition of each of Comparative example 1-1, Comparative example 1-2, Comparative example 1-3 and Example 1-1, and mixed at the mixing speed of 70 rpm for 2 min, and then mixed at the mixing speed of 10 rpm for 3 min. Bubbles created in the mixing process are removed to manufacture concrete.

The slump flow test of KS F 2594 is performed on the concrete manufactured according to each of Comparative example 1-1, Comparative example 1-2, Comparative example 1-3 and Example 1-1. Test pieces for each of compressive strength, tensile strength and airtightness tests are made by molding, wet curing is performed using a curing blanket and a vinyl sheet for 1 day while maintaining the temperature of 18 to 22° C. and the humidity of 92 to 98%. The mold is removed for demolding. Subsequently, after high temperature thermal curing for 1 day in water of the temperature of 83 to 87° C., compressive strength is evaluated in accordance with KS F 2405. Tensile strength is evaluated in accordance with the Korea Concrete Institute Standard KCI-UC 105, and airtightness is evaluated using Torrent direct tension tester. Shrinkage is evaluated by testing for 56 days in accordance with KS F 2586.

Table 1 below gives the details of each of Comparative example 1-1, Comparative example 1-2, Comparative example 1-3 and Example 1-1. Table 2 below gives the test results obtained.

TABLE 1

| | | | | | | | | Admixture |
|---|---|---|---|---|---|---|---|---|
| | | | | Reactive | | Fine | | (Polycarbonate- |
| Unit | | | | powder | Filler | aggregate | SAP-Attached | based high |
| (Parts by | | Mixing water | | (Silica | (Quartz fine | (Silica | Steel | performance |
| weight) | Cement | Basic | Additional | fume) | powder) | sand) | Fiber | water reducer |
| Comparative | 100 | 20 | — | 20 | 25 | 110 | Steel fiber | 0.45 |
| example 1-1 | | | | | | | without | |
| | | | | | | | attached SAP | |
| | | | | | | | 22 | |
| Comparative | 100 | 20 | — | 20 | 25 | 110 | Steel fiber | 0.45 |
| example 1-2 | | | | | | | without | |
| | | | | | | | attached | |
| | | | | | | | SAP 22/ | |
| | | | | | | | Separate SAP | |
| | | | | | | | 1 | |
| Comparative | 100 | 20 | — | 20 | 25 | 110 | SAP-Attached | 0.45 |
| example 1-3 | | | | | | | Steel Fiber 23 | |
| Example 1-1 | 100 | 20 | 0.81 | 20 | 25 | 110 | SAP-Attached | 0.45 |
| | | | | | | | Steel Fiber 23 | |

TABLE 2

| | Slump flow | Compressive | Tensile strength | Shrinkage | Airtightness |
|---|---|---|---|---|---|
| | (mm) | strength (MPa) | (MPa) | (×10⁻⁶) | (×10⁻¹⁶m²) |
| Comparative | 760 | 176 | 12.7 | 650 | 0.0045 |
| example 1-1 | | | | | |
| Comparative | 620 | 156 | 10.2 | 340 | 0.0068 |
| example 1-2 | | | | | |
| Comparative | 640 | 175 | 13.2 | 325 | 0.0042 |
| example 1-3 | | | | | |
| Example 1-1 | 770 | 178 | 14.3 | 311 | 0.0033 |

As shown in the above Table 2, in the case of Comparative example 1-2 using each of SAP and steel fiber alone, the slump flow is greatly reduced and the workability is reduced compared to Comparative example 1-1 using only steel fibers alone without using SAP. Compressive strength, tensile strength and airtightness are also reduced due to pores formed as much as shrinkage in the curing process, but autogenous shrinkage is also greatly reduced. According to analysis, lower workability of Comparative example 1-2 than Comparative example 1-1 would be due to the absorption of the mixing water by SAP. Lower airtightness of Comparative example 1-2 than Comparative example 1-1 would be due to pores formed as much as the shrinkage of SAP in the curing.

Comparative example 1-3 shows similar results to Comparative example 1-1 in compressive strength, tensile strength and airtightness except workability. However, Comparative example 1-3 has a significant reduction in autogenous shrinkage. Example 1-1 has higher workability, compressive strength, tensile strength and airtightness than Comparative example 1-1, and a significant reduction in shrinkage.

The above results reveal that with the ultra-high density concrete composite according to the present disclosure using SAP-Attached Fibers, and in addition to basic mixing water, further including additional mixing water, it is possible to manufacture a concrete member with greatly improved constructability, mechanical properties, shrinkage characteristics and airtightness.

Subsequently, to verify the influence and effect of “SAP-Attached Organic Fibers” using organic fiber as reinforcing fiber and additional mixing water, comparative examples and examples of the present disclosure are each prepared with the following composition.

### Comparative Example 2-1

Concrete composition including cement, silica fume as reactive powder, quartz fine powder as filler, silica sand as fine aggregate, a polycarbonate-based high performance water reducer as admixture, basic mixing water, and PVA fibers as reinforcing fiber without SAP and additional mixing water.

The details of the concrete composition of Comparative example 2-1 are as follows:
Cement of 100 parts by weight;
Silica fume of 20 parts by weight;
Quartz fine powder of 25 parts by weight;
Silica sand of 110 parts by weight;
Polycarbonate-based high performance water reducer of 0.47 parts by weight;
Basic mixing water of 20 parts by weight; and
PVA fibers of 2.5 parts by weight.

### Comparative Example 2-2

Concrete composition including cement, silica fume as reactive powder, quartz fine powder as filler, silica sand as fine aggregate, a polycarbonate-based high performance water reducer as admixture, basic mixing water, PVA fibers as reinforcing fiber, and SAP without additional mixing water.

In the Comparative example 2-2, SAP is not attached to the PVA fibers, and therefore, SAP is separate from the PVA fibers.

The details of the concrete composition of Comparative example 2-2 are as follows:
Cement of 100 parts by weight;
Silica fume of 20 parts by weight;
Quartz fine powder of 25 parts by weight;
Silica sand of 110 parts by weight;
Polycarbonate-based high performance water reducer of 0.47 parts by weight;
Basic mixing water of 20 parts by weight;
PVA fibers of 2.5 parts by weight; and
SAP of 1 parts by weight.

### Comparative Example 2-3

Concrete composition including cement, silica fume as reactive powder, quartz fine powder as filler, silica sand as fine aggregate, a polycarbonate-based high performance water reducer as admixture, basic mixing water, and SAP-Attached PVA Fibers as reinforcing fiber without additional mixing water.

The details of the concrete composition of Comparative example 2-3 are as follows:
Cement of 100 parts by weight;
Silica fume of 20 parts by weight;
Quartz fine powder of 25 parts by weight;
Silica sand of 110 parts by weight;
Polycarbonate-based high performance water reducer of 0.47 parts by weight;
Basic mixing water of 20 parts by weight; and
SAP-Attached PVA Fibers of 2.6 parts by weight.

### Example 2-1

Ultra-high density concrete composition including cement, silica fume as reactive powder, quartz fine powder as filler, silica sand as fine aggregate, a polycarbonate-based high performance water reducer as admixture, basic mixing water, additional mixing water, and SAP-Attached Steel Fibers as reinforcing fiber.

The details of the concrete composition of Example 2-1 are as follows:
Cement of 100 parts by weight;
Silica fume of 20 parts by weight;
Quartz fine powder of 25 parts by weight;
Silica sand of 110 parts by weight;
Polycarbonate-based high performance water reducer of 0.47 parts by weight;
Basic mixing water of 20 parts by weight;
Additional mixing water of 0.71 parts by weight; and
SAP-Attached PVA Fibers of 2.6 parts by weight.

Common to all of Comparative example 2-1, Comparative example 2-2, Comparative example 2-3 and Example 2-1 of the present invention, cement, silica fume, quartz fine powder and silica sand are put together into a mixer and mixed by the dry mix process at the mixing speed of 30 rpm for 1 min 30 sec. such that those materials are uniformly distributed. Sequentially, basic mixing water and admixture are added to the dry mixed materials as described and mixed at the mixing speed of 50 rpm for 2 min 30 sec. Thereafter, steel fibers, SAP, SAP-Attached PVA Fibers and additional mixing water are additionally fed to the mixture according to the composition of each of Comparative example 2-1, Comparative example 2-2, Comparative example 2-3 and Example 2-1, and mixed at the mixing speed of 70 rpm for 2 min, and then mixed at the mixing speed of 10 rpm for 3 min. Bubbles created in the mixing process are removed to manufacture concrete.

The slump flow test of KS F 2594 is performed on the concrete manufactured according to each of Comparative example 2-1, Comparative example 2-2, Comparative example 2-3 and Example 2-1. Test pieces for each of compressive strength, tensile strength and airtightness tests are made by molding, wet curing is performed using a curing blanket and a vinyl sheet for 1 day while maintaining the temperature of 18 to 22° C. and the humidity of 92 to 98%. The mold is removed for demolding. Subsequently, after high temperature thermal curing for 1 day in water of the temperature of 83 to 87° C., compressive strength is evaluated in accordance with KS F 2405. Tensile strength is evaluated in accordance with the Korea Concrete Institute Standard KCI-UC 105, and airtightness is evaluated using Torrent direct tension tester. Shrinkage is evaluated by testing for 56 days in accordance with KS F 2586.

Table 3 below gives the details of each of Comparative example 2-1, Comparative example 2-2, Comparative example 2-3 and Example 2-1. Table 4 below gives the test results obtained.

TABLE 3

| | | | | | | | | Admixture |
|---|---|---|---|---|---|---|---|---|
| | | | | Reactive | | Fine | | (Polycarbonate- |
| Unit | | | | powder | Filler | aggregate | SAP-Attached | based high |
| (Parts by | | Mixing water | | (Silica | (Quartz fine | (Silica | PVAI | performance |
| weight) | Cement | Basic | Additional | fume) | powder) | sand) | Fiber | water reducer |
| Comparative | 100 | 20 | — | 20 | 25 | 110 | PVA fiber | 0.47 |
| example 2-1 | | | | | | | without | |
| | | | | | | | attached SAP | |
| | | | | | | | 2.5 | |
| Comparative | 100 | 20 | — | 20 | 25 | 110 | PVA fiber | 0.47 |
| example 2-2 | | | | | | | without | |
| | | | | | | | attached | |
| | | | | | | | SAP 2.5/ | |
| | | | | | | | Separate SAP | |
| | | | | | | | 1 | |
| Comparative | 100 | 20 | — | 20 | 25 | 110 | SAP-Attached | 0.47 |
| example 2-3 | | | | | | | PAV Fiber 2.6 | |
| Example 2-1 | 100 | 20 | 0.71 | 20 | 25 | 110 | SAP-Attached | 0.47 |
| | | | | | | | PVA Fiber 2.6 | |

TABLE 4

| | Slump flow | Compressive | Tensile strength | Shrinkage | Airtightness |
|---|---|---|---|---|---|
| | (mm) | strength (MPa) | (MPa) | (×10⁻⁶) | (×10⁻¹⁶m²) |
| Comparative | 740 | 156 | 10.3 | 570 | 0.0052 |
| example 2-1 | | | | | |
| Comparative | 600 | 132 | 7.3 | 278 | 0.0086 |
| example 2-2 | | | | | |
| Comparative | 610 | 156 | 11.1 | 255 | 0.0049 |
| example 2-3 | | | | | |
| Example 2-1 | 760 | 159 | 12.4 | 223 | 0.0042 |

As shown in the above Table 4, the influence of the use of SAP-Attached PVA Fibers and the influence of the use of additional mixing water show nearly similar results to those of Comparative example 1-1, Comparative example 1-2, Comparative example 1-3 and Example 1-1 described above in relation to Table 2. According the results of Table 54, shrinkage of Comparative example 2-1 using PVA fiber alone without using SAP is increased. However, shrinkage of Comparative example 2-2 additionally using SAP separately from PVA fiber is reduced. Workability, compressive strength, tensile strength and airtightness of Comparative example 2-2 are reduced. In contrast, Comparative example 2-3 using SAP-Attached PVA Fibers has similar compressive strength, tensile strength and airtightness to Comparative example 2-1 and Comparative example 2-2. Shrinkage of Comparative example 2-3 is greatly increased. However, Comparative example 2-3 shows low workability.

The results show that Example 2-1 using additional mixing water ensures sufficient compressive strength, tensile strength and airtightness. Further, the results as above show that shrinkage of Example 2-1 is greatly reduced. Such results also ensures good workability of Example 2-1.

The results also reveal that with the ultra-high density concrete composition of the present disclosure using SAP-Attached PVA Fibers, and in addition to basic mixing water, further using additional mixing water, it is possible to manufacture a concrete member with greatly improved constructability, mechanical properties, shrinkage characteristics and airtightness.

To verify the influence and effect of the amount of “SAP-Attached Steel Fibers” used as reinforcing fiber, comparative examples and examples of the present disclosure are each prepared as the followings.

### Comparative Example 3-1

Concrete composition including cement, silica fume as reactive powder, quartz fine powder as filler, silica sand as fine aggregate, a polycarbonate-based high performance water reducer as admixture, basic mixing water, additional mixing water and SAP-Attached Steel Fibers as reinforcing fiber.

The details of the concrete composition of Comparative example 3-1 are as follows:
Cement of 100 parts by weight;
Silica fume of 20 parts by weight;
Quartz fine powder of 25 parts by weight;
Silica sand of 110 parts by weight;
Polycarbonate-based high performance water reducer of 0.45 parts by weight;
Basic mixing water of 20 parts by weight;
Additional mixing water of 0.22 parts by weight; and
SAP-Attached Steel Fibers of 5 parts by weight.

### Example 3-1

Concrete composition including cement, silica fume as reactive powder, quartz fine powder as filler, silica sand as fine aggregate, a polycarbonate-based high performance water reducer as admixture, basic mixing water, additional mixing water and SAP-Attached Steel Fibers as reinforcing fiber.

The details of the concrete composition of Example 3-1 are as follows:
Cement of 100 parts by weight;
Silica fume of 20 parts by weight;
Quartz fine powder of 25 parts by weight;
Silica sand of 110 parts by weight;
Polycarbonate-based high performance water reducer of 0.45 parts by weight;
Basic mixing water of 20 parts by weight;
Additional mixing water of 0.39 parts by weight; and
SAP-Attached Steel Fibers of 10 parts by weight.

### Example 3-2

Concrete composition including cement, silica fume as reactive powder, quartz fine powder as filler, silica sand as fine aggregate, a polycarbonate-based high performance water reducer as admixture, basic mixing water, additional mixing water and SAP-Attached Steel Fibers as reinforcing fiber.

The details of the concrete composition of Example 3-2 are as follows:
Cement of 100 parts by weight;
Silica fume of 20 parts by weight;
Quartz fine powder of 25 parts by weight;
Silica sand of 110 parts by weight;
Polycarbonate-based high performance water reducer of 0.45 parts by weight;
Basic mixing water of 20 parts by weight;
Additional mixing water of 0.81 parts by weight; and
SAP-Attached Steel Fibers of 23 parts by weight.

### Example 3-3

Concrete composition including cement, silica fume as reactive powder, quartz fine powder as filler, silica sand as fine aggregate, a polycarbonate-based high performance water reducer as admixture, basic mixing water, additional mixing water and SAP-Attached Steel Fibers as reinforcing fiber.

The details of the concrete composition of Example 3-3 are as follows:
Cement of 100 parts by weight;
Silica fume of 20 parts by weight;
Quartz fine powder of 25 parts by weight;
Silica sand of 110 parts by weight;
Polycarbonate-based high performance water reducer of 0.45 parts by weight;
Basic mixing water of 20 parts by weight;
Additional mixing water of 1.37 parts by weight; and
SAP-Attached Steel Fibers of 40 parts by weight.

### Comparative Example 3-2

Concrete composition including cement, silica fume as reactive powder, quartz fine powder as filler, silica sand as fine aggregate, a polycarbonate-based high performance water reducer as admixture, basic mixing water, additional mixing water and SAP-Attached Steel Fibers as reinforcing fiber.

The details of the concrete composition of Comparative Example 3-2 are as follows:
Cement of 100 parts by weight;
Silica fume of 20 parts by weight;
Quartz fine powder of 25 parts by weight;
Silica sand of 110 parts by weight;
Polycarbonate-based high performance water reducer of 0.45 parts by weight;
Basic mixing water of 20 parts by weight;
Additional mixing water of 1.69 parts by weight; and
SAP-Attached Steel Fibers of 50 parts by weight.

Common to all of Comparative example 3-1, Example 3-1, Example 3-2, Example 3-3 of the present invention and Comparative example 3-2, cement, silica fume, quartz fine powder and silica sand are put together into a mixer and mixed by the dry mix process at the mixing speed of 30 rpm for 1 min 30 sec. such that those materials are uniformly distributed. Sequentially, basic mixing water and admixture are added to the dry mixed materials as described and mixed at the mixing speed of 50 rpm for 2 min 30 sec. Thereafter, SAP-Attached Steel Fibers and additional mixing water are additionally fed to the mixture according to the composition of each of Comparative example 3-1, Example 3-1, Example 3-2, Example 3-3 and Comparative example 3-2, and mixed at the mixing speed of 70 rpm for 2 min, and then mixed at the mixing speed of 10 rpm for 3 min. Bubbles created in the mixing process are removed to manufacture concrete.

The slump flow test of KS F 2594 is performed on the concrete manufactured according to each of Comparative example 3-1, Example 3-1, Example 3-2, Example 3-3 and Comparative example 3-2, test pieces for each of compressive strength, tensile strength, and airtightness tests are made by molding, wet curing is performed using a curing blanket and a vinyl sheet for 1 day while maintaining the temperature of 18 to 22° C. and the humidity of 92 to 98%. The mold is removed for demolding. Subsequently, after high temperature thermal curing for 1 day in water of the temperature of 83 to 87° C., compressive strength is evaluated in accordance with KS F 2405, tensile strength is evaluated in accordance with the Korea Concrete Institute Standard KCI-UC 105, and airtightness is evaluated using Torrent direct tension tester. Autogenous shrinkage is evaluated by testing for 56 days in accordance with KS F 2586.

Table 5 below gives the details of each of Comparative example 3-1, Example 3-1, Example 3-2, Example 3-3 and Comparative example 3-2. Table 6 below gives the test results obtained

TABLE 5

| | | | | | | | | Admixture |
|---|---|---|---|---|---|---|---|---|
| | | | | Reactive | | Fine | | (Polycarbonate- |
| Unit | | | | powder | Filler | aggregate | SAP-Attached | based high |
| (Parts by | | Mixing water | | (Silica | (Quartz fine | (Silica | Steel | performance |
| weight) | Cement | Basic | Additional | fume) | powder) | sand) | Fiber | water reducer |
| Comparative | 100 | 20 | 0.22 | 20 | 25 | 110 | 5 | 0.45 |
| example 3-1 | | | | | | | | |
| Example 3-1 | 100 | 20 | 0.39 | 20 | 25 | 110 | 10 | 0.45 |
| Example 3-2 | 100 | 20 | 0.81 | 20 | 25 | 110 | 23 | 0.45 |
| Example 3-3 | 100 | 20 | 1.37 | 20 | 25 | 110 | 40 | 0.45 |
| Comparative | 100 | 20 | 1.69 | 20 | 25 | 110 | 50 | 0.45 |
| example 3-1 | | | | | | | | |

TABLE 6

| | Slump flow | Compressive | Tensile strength | Shrinkage | Airtightness |
|---|---|---|---|---|---|
| | (mm) | strength (MPa) | (MPa) | (×10⁻⁶) | (×10⁻¹⁶m²) |
| Comparative | 850 | 167 | 7.7 | 580 | 0.0045 |
| example 3-1 | | | | | |
| Example 3-1 | 800 | 173 | 10.1 | 378 | 0.0035 |
| Example 3-2 | 770 | 178 | 14.3 | 311 | 0.0033 |
| Example 3-3 | 710 | 179 | 18.8 | 278 | 0.0041 |
| Comparative | 620 | 168 | 17.8 | 267 | 0.0078 |
| example 3-2 | | | | | |

As shown in the above Table 6, with the increasing amount of SAP-Attached Steel Fibers, the slump flow is reduced. It is due to the facts that the amount of SAP and the amount of steel fiber are increased together. However, it is found that the slump flow is maintained at 700 mm or more until the amount of SAP-Attached Steel Fibers reaches 40 parts by weight. It is found that both the compressive strength and the tensile strength are improved in proportion to an increase in the amount of SAP-Attached Steel Fibers until the amount of SAP-Attached Steel Fibers reaches 40 parts by weight, but when the amount of SAP-Attached Steel Fibers is 50 parts by weight, both the compressive strength and the tensile strength are reduced. According to analysis, it is because the pore volume is increased due to the increased amount of SAP used rather than the increased amount of steel fiber used, and with the decreasing workability, the airtightness is reduced. It is found that the shrinkage is decreased with the increasing amount of SAP-Attached Steel Fibers used, and this is related to the influence of SAP.

It is found that the airtightness is increased in proportion to the amount of SAP-Attached Steel Fibers used until the amount of SAP-Attached Steel Fibers reaches 23 parts by weight, but when the amount of SAP-attached steel fiber is 40 parts by weight, the airtightness is slightly reduced. When the amount of SAP-Attached Steel Fibers is 50 parts by weight, the airtightness is rapidly reduced. In the same way as the results of compressive strength and tensile strength, according to analysis, it is because with the increasing amount of SAP used, the pore volume is increased, and with the decreasing workability, the airtightness is reduced. As described above, when the amount of SAP-Attached Steel Fibers is less than 10 parts by weight, the effect of use is not so large, and when the amount of SAP-Attached Steel Fibers is larger than 40 parts by weight, rather some adverse effects occur and the production costs are greatly reduced. Accordingly, as with the ultra-high density concrete composition of the present disclosure, a desirable amount of SAP-Attached Steel Fibers is 10 to 40 parts by weight based on 100 parts by weight of cement, and it is possible to manufacture ultra-high density concrete with improved workability, mechanical properties, shrinkage characteristics and airtightness by changing the influence on the properties through the use of additional mixing water.

Accordingly, with the ultra-high density concrete composition of the present disclosure, it is possible to manufacture concrete members having dense structures with very high density, and in particular, it is possible to manufacture very efficiently and successfully concrete structures such as near-vacuum tubes for hyperloop transportation system that can carry vehicles at high speeds of 1000 km/h or more.

What is claimed is:

1. Ultra-high density concrete composition comprising:
cement of 100 parts by weight;
reactive powder of 10 to 30 parts by weight;
filler of 15 to 30 parts by weight;
fine aggregate of 100 to 150 parts by weight;
admixture of 0.1 to 1 parts by weight;
mixing water; and
reinforcing fibers;
wherein the reinforcing fibers are super-absorbent polymer (SAP)-Attached Fibers in which SAP is mixed with the reinforcing fibers and SAP is uniformly attached to a surface of the reinforcing fibers by an adhesive.

2. The ultra-high density concrete composition according to claim 1, wherein SAP-Attached Fibers are manufactured by:
metering 0.1 to 1.5 weight % of SAP and 98.5 to 99.5 weight % of reinforcing fibers based on 100 weight % of the total weight of the mixture of SAP and the reinforcing fibers; and
mixing SAP and the reinforcing fibers with the adhesive; and
drying the mixture of SAP and the reinforcing fibers.

3. The ultra-high density concrete composition according to claim 1, wherein SAP-Attached Fibers are SAP-Attached Steel Fibers, in which the reinforcing fibers to which SAP is attached are steel fibers;
wherein SAP-Attached Steel Fibers are included in the ultra-high density concrete composition in an amount of 10 to 40 parts by weight based on 100 parts by weight of cement; and
wherein mixing water includes basic mixing water and additional mixing water;
wherein the basic mixing water is included in an amount of 15 to 25 parts by weight based on 100 parts by weight of cement, and the additional mixing water is included in an amount of 0.39 to 1.39 parts by weight based on 100 parts by weight of cement.

4. The ultra-high density concrete composition according to claim 1, wherein SAP-Attached Fibers are SAP-Attached Organic Fibers, in which the reinforcing fibers to which SAP is attached are organic fibers;
wherein SAP-Attached Organic Fibers are included in the ultra-high density concrete composition in an amount of 1 to 5 parts by weight based on 100 parts by weight of cement; and
wherein mixing water includes basic mixing water and additional mixing water;
wherein the basic mixing water is included in an amount of 15 to 25 parts by weight based on 100 parts by weight of cement, and the additional mixing water is included in an amount of 0.39 to 1.70 parts by weight based on 100 parts by weight of cement.

5. A method for manufacturing an ultra-high density concrete composition comprising cement, reactive powder, filler, fine aggregate, admixture, mixing water and reinforcing fibers, the method comprising:
metering 10 to 30 parts by weight of reactive powder, 15 to 30 parts by weight of filler and 100 to 150 parts by weight of fine aggregate based on 100 parts by weight of cement, and uniformly mixing the cement, the reactive powder, the filler and the fine aggregate (step 1); and
adding admixture, mixing water and reinforcing fiber to the mixture of the step 1 and mixing together (step 2),
wherein 0.1 to 1 parts by weight of admixture is metered and fed based on 100 parts by weight of cement, and
wherein reinforcing fibers are super-absorbent polymer (SAP)-Attached Fibers in which SAP is mixed with the reinforcing fibers and therefore, SAP is uniformly attached to a surface of the reinforcing fibers by an adhesive.

6. The method for manufacturing ultra-high density concrete composition according to claim 5, wherein SAP-Attached Fibers are manufactured by:
metering 0.1 to 1.5 weight % of SAP and 98.5 to 99.5 weight % of reinforcing fibers based on 100 weight % of the total weight of the mixture of SAP and the reinforcing fibers; and
mixing SAP and the reinforcing fibers with the adhesive; and
drying the mixture of SAP and the reinforcing fibers.

7. The method for manufacturing ultra-high density concrete composition according to claim 5, wherein SAP-Attached Fibers are SAP-Attached Steel Fibers, in which the reinforcing fibers to which SAP is attached are steel fibers,
wherein the mixing water includes basic mixing water and additional mixing water;
wherein the step 1 comprises metering 15 to 25 parts by weight of basic mixing water based on 100 parts by weight of cement, and uniformly mixing the basic mixing water with the cement, the reactive powder, the filler and the fine aggregate, and
wherein the step 2 comprises metering 0.39 to 1.39 parts by weight of additional mixing water based on 100 parts by weight of cement, metering 10 to 40 parts by weight of SAP-Attached Steel Fibers based on 100 parts by weight of cement, adding the additional mixing water and SAP-Attached Steel Fibers and mixing together.

8. The method for manufacturing ultra-high density concrete according to claim 5, wherein SAP-Attached Fibers are SAP-Attached Organic Fibers, in which the reinforcing fibers to which SAP is attached are organic fibers,
wherein the mixing water includes basic mixing water and additional mixing water;
wherein the step 1 comprises metering 15 to 25 parts by weight of basic mixing water based on 100 parts by weight of cement, and uniformly mixing the basic mixing water with the cement, the reactive powder, the filler and the fine aggregate, and
wherein the step 2 comprises metering 0.39 to 1.70 parts by weight of additional mixing water based on 100 parts by weight of cement, metering 1 to 5 parts by weight of SAP-Attached Organic Fibers based on 100 parts by weight of cement, adding the additional mixing water and SAP-Attached Organic Fibers and mixing together.

9. A method for manufacturing an ultra-high density concrete member using ultra-high density concrete composite according to claim 1, the method comprising:
pouring the ultra-high density concrete composite into a mold, curing and demolding;
covering an upper surface of the ultra-high density concrete composite poured into the mold with a curing blanket of vinyl to prevent the evaporation of moisture from the ultra-high density concrete composite during curing, and after 1 to 2 days while maintaining temperature of 15 to 40° C. and humidity of 90% or more, demolding by removing the mold; and
after the demolding is completed, performing high temperature thermal curing for 1 to 3 days while maintaining the temperature of 50 to 98° C. and the humidity of 95% or more, or performing wet curing for 7 days or more while maintaining the temperature of 15° C. or more and the humidity of 95% or more.

10. The method for manufacturing an ultra-high density concrete member according to claim 9, wherein the super-absorbent polymer (SAP)-Attached Fibers are SAP-Attached Steel Fibers, in which the reinforcing fibers to which SAP is attached are steel fibers,
wherein SAP-Attached Steel Fibers are included in an amount of 10 to 40 parts by weight based on 100 parts by weight of cement;
wherein mixing water includes basic mixing water and additional mixing water; and
wherein basic mixing water is included in an amount of 15 to 25 parts by weight based on 100 parts by weight of cement, and additional mixing water is included in an amount of 0.39 to 1.39 parts by weight based on 100 parts by weight of cement.

11. The method for manufacturing an ultra-high density concrete member according to claim 9, wherein the super-absorbent polymer (SAP)-Attached Fibers are SAP-Attached Organic Fibers, in which the reinforcing fibers to which SAP is attached are organic fibers,
wherein SAP-Attached Organic Fibers are included in an amount of 1 to 5 parts by weight based on 100 parts by weight of cement;
wherein mixing water includes basic mixing water and additional mixing water; and
wherein basic mixing water is included in an amount of 15 to 25 parts by weight based on 100 parts by weight of cement, and the additional mixing water is included in an amount of 0.39 to 1.70 parts by weight based on 100 parts by weight of cement.

12. An ultra-high density concrete member manufactured using ultra-high density concrete composition according to claim 1, the ultra-high density concrete member manufactured by:
pouring the ultra-high density concrete composite into a mold, curing and demolding;
covering an upper surface of the ultra-high density concrete composite poured into the mold with a curing blanket of vinyl to prevent the evaporation of moisture from the ultra-high density concrete composite during curing, and after 1 to 2 days while maintaining temperature of 15 to 40° C. and humidity of 90% or more, demolding by removing the mold; and
after the demolding is completed, performing high temperature thermal curing for 1 to 3 days while maintaining the temperature of 50 to 98° C. and the humidity of 95% or more, or performing wet curing for 7 days or more while maintaining the temperature of 15° C. or more and the humidity of 95% or more.

13. The ultra-high density concrete member according to claim 12, wherein the ultra-high density concrete member is a near-vacuum tube used in hyperloop transportation system.
